(19) United States
(12) Patent Application Publication
(10) Pub. No.: US 2014/0237070 A1
(43) Pub. Date: Aug. 21, 2014

(54) NETWORK-ATTACHED STORAGE MANAGEMENT IN A CLOUD ENVIRONMENT

(71) Applicant: LG CNS CO., LTD., (US)

(72) Inventors: Eun Young Choi, Seoul (KR); Yoon Hee Shin, Seoul (KR); San Sun Park, Seoul (KR); Sang Deuk Shim, Seoul (KR)

(73) Assignee: LG CNS CO., LTD., Seoul (KR)

(21) Appl. No.: 13/770,114

(22) Filed: Feb. 19, 2013

(51) Int. Cl. H04L 29/08

(52) U.S. Cl. CPC H04L 67/1097
USPC 709/216

(57) ABSTRACT

Embodiments of the present invention provide an automated network-attached storage (NAS) management system in a cloud computing environment. Specifically, a server communicates with network storage clients via a network connection. The network storage clients comprise a unified storage zone for storing data. At least part of the unified storage zone is allocated to a site as site data. A virtual desktop interface (VDI) is used by a user client device to interact with management services. A management services layer provides the management services for the user client device by using requests from the user client device to perform operations relating to the management of the site data.

### TECHNICAL FIELD

In general, the present invention relates to a networked computing environment. Specifically, the present invention relates to network-attached storage in a cloud computing environment.

### BACKGROUND

There is an increasing demand for systems that store large amounts of data. Many companies struggle to provide scalable, cost-effective storage solutions for large amounts of data stored in files (e.g., terabytes of data). One type of prior art system used to store data for computers is known as network-attached storage (“NAS”). In a NAS configuration, a computer, such as a server, is coupled to physical storage, such as one or more hard disk drives. The NAS server is accessible over a network. In order to access the storage, the client computer submits requests to the server to store and retrieve data.

Conventional NAS technology has several inherent limitations. First, NAS systems are severely impacted by their fundamental inability to scale performance and capacity. Current NAS systems only scale performance within the limits of a single NAS server with a single network connection. Thus, a single NAS server can only scale capacity to a finite number of disks attached to that NAS server. These fundamental limitations of current file storage systems create a variety of challenges. First, customers must use multiple NAS systems to meet capacity and performance requirements. The use of multiple NAS systems requires the customer to manage multiple file systems and multiple NAS system images. These attempts lead to inefficient utilization of storage assets, because files must be manually distributed across multiple NAS systems to meet overall capacity and performance requirements. Invariably, this leaves pockets of unused capacity in the multiple NAS systems. Moreover, existing NAS solutions are frequently cumbersome and inefficient. File servers housing sensitive and confidential information are maintained on file servers of individual organizations.

Many times the physical location of the data is not a secure environment. In addition, the amount of data storage may be extremely large, and an event requiring data restoration or recovery may not take place fast enough. These issues result in substantially higher management costs to the end-user as well as high acquisition costs to purchase proprietary NAS systems. Heretofore, several unsuccessful attempts have been made to address these shortcomings.

U.S. Patent Application 20090248847 discloses a storage system included in the cluster system which includes a plurality of volumes and a plurality of virtual servers utilizing at least one or more volumes of the plurality of volumes for data processing. Each of the plurality of virtual servers can access all the plurality of volumes, and the volume utilized by the plurality of virtual servers to process data corresponds to the virtual servers.

U.S. Patent Application 20110047340 discloses a system and method for backing up a virtual machine executing on a virtualization server computer in which a snapshot of a virtual disk image file of the virtual machine may be created on a network-attached storage (NAS) device coupled to the virtualization server computer.

U.S. Pat. No. 7,272,654 discloses multiple network-attached storage (NAS) appliances that are pooled together by a virtual NAS translator to form one common name space that is visible to clients.

U.S. Pat. No. 7,370,083 discloses a system and method for using free storage capacity on a plurality of storage media as a virtual storage device on a computer network comprising a plurality of computers.

U.S. Patent Application 2003/0145086 discloses a scalable network-attached storage system, a secure scalable network-attached storage system and a peer-based storage network all with high performance and scalability are described by this invention, which uses dynamic access distribution to avoid scaling penalties.

U.S. Pat. No. 7,774,325 discloses a distributed data storage system which stores a single image file system across a plurality of physical storage.

None of these references, however, address all the issues of the prior art.

### SUMMARY

Embodiments of the present invention provide an automated network-attached storage (NAS) management system in a cloud computing environment. Specifically, a server communicates with network storage clients via a network connection. The network storage clients comprise a unified storage zone for storing data. At least part of the unified storage zone is allocated to a site as site data. A virtual desktop interface (VDI) is used by a user client device to interact with management services. A management services layer provides the management services for the user client device by using requests from the user client device to perform operations relating to the management of the site data.

A first aspect of the present invention provides a network-attached storage (NAS) management system in a cloud computing environment, comprising: a network connection; and a server, comprising: a processor, memory, and a computer-readable storage medium; an operating environment stored on the computer-readable storage medium and executing on the processor; a storage adapter through which to communicate with a plurality of network storage clients via the network connection, wherein the plurality of network storage clients comprise a unified storage zone for storing data, wherein at least part of the unified storage zone is allocated to a site as site data; a virtual desktop interface (VDI) that is used by a user client device to interact with management services; and a management services layer that provides the management services for the user client device, wherein the management services comprise using requests that are configurable by the user client device and wherein the requests are used to perform operations relating to the management of the site data.

A second aspect of the present invention provides a method for managing a network-attached storage (NAS) management system in a cloud computing environment, comprising: providing a server configured to communicate using a storage adapter with a plurality of network storage clients via a network connection, wherein the plurality of network storage clients comprise a unified storage zone for storing data, wherein at least part of the unified storage zone is allocated to a site as site data; providing a virtual desktop interface (VDI) that is used by a user client device to interact with management services; and providing a management services layer that provides the management services for the user client device, wherein the management services comprise using requests that are configurable by the user client device and wherein the requests are used to perform operations relating to the management of the site data.

A third aspect of the present invention provides computer program product for managing a network-attached storage (NAS) management system in a cloud computing environment, the computer program product comprising a computer readable storage media, and program instructions stored on the computer readable storage media, to: communicate with a plurality of network storage clients using a network adapter via a network connection, wherein the plurality of network storage clients comprise a unified storage zone for storing data; allocate at least part of the unified storage zone is allocated a site as site data; establish a virtual desktop interface (VDI) that is used by a user client device to interact with management services; establish a management services layer that provides the management services for the user client device, wherein the management services comprise using a request that is configurable by the user client device; and perform operations relating to the management of the site data based on the request.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts an example file server management solution according to an embodiment of the present invention.

FIG. 5 depicts an example schematic for an individual folder management processing flow according to an embodiment of the present invention.

FIG. 6 depicts a schematic for an example cloud NAS management system according to an aspect of the present invention is shown.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As used herein, the term “communication link” is intended to include any means of connecting one location to another for the purpose of transmitting and receiving information.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Demands in high performance and high availability of data with lower cost and lower personnel involvement in enterprise environments have created many opportunities in cloud computing. Some companies started realizing that their economies of scale help them create storage infrastructure at a fraction of the cost, both in capital expenditures and operational expenditures, of traditional enterprise storage infrastructure. Recently, large service providers have offered storage infrastructure in a cloud rather than local storage. One part of the infrastructure that provides a large amount of savings is storage.

Cloud NAS is a subset of cloud storage, which is also known as Storage as a Service (SaaS). NAS is generally associated with a storage device in a data center or office. If you take that device and move it far away, maybe where you don't even know the location, and you access it over the Internet using a software module on the host itself, you're taking the functionality of the NAS device and you are moving it into the cloud. Data in the cloud NAS is accessed as if it is a local device.

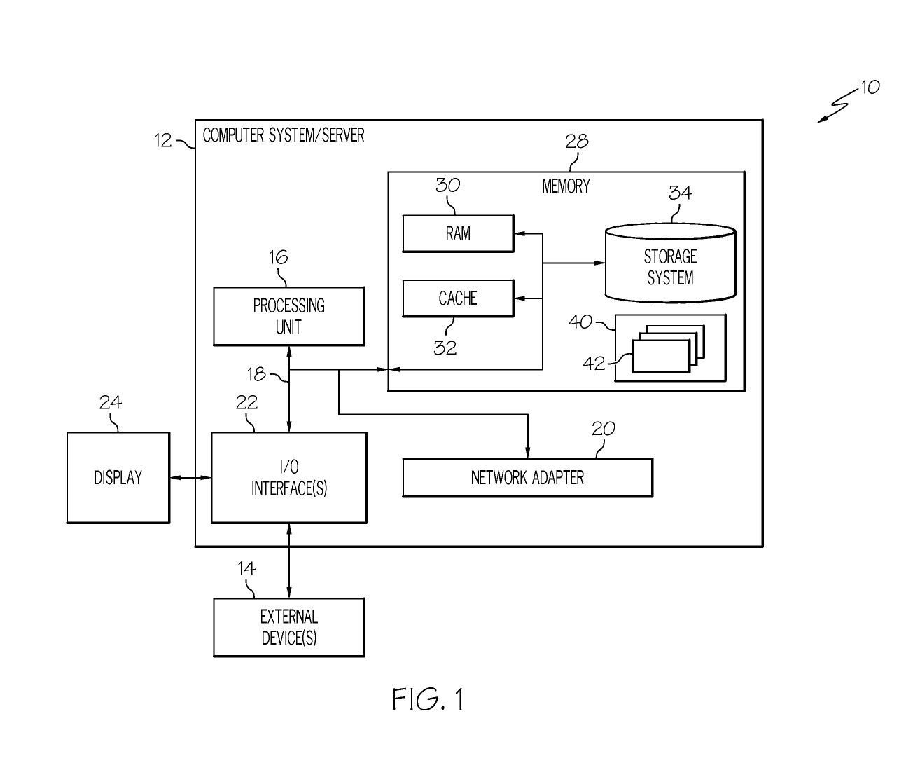

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

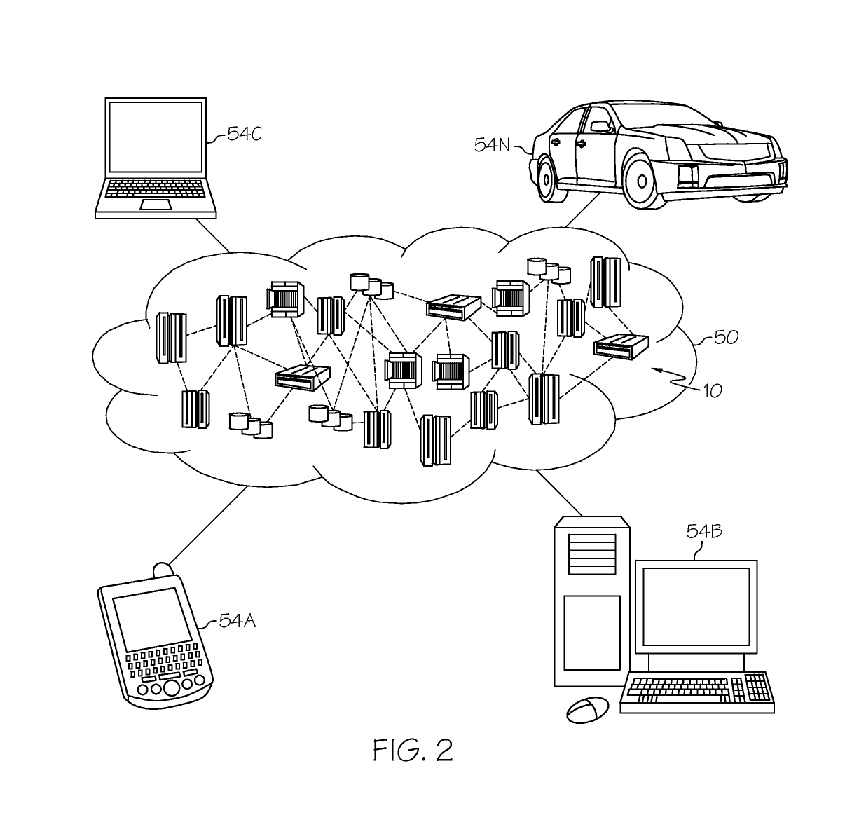

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

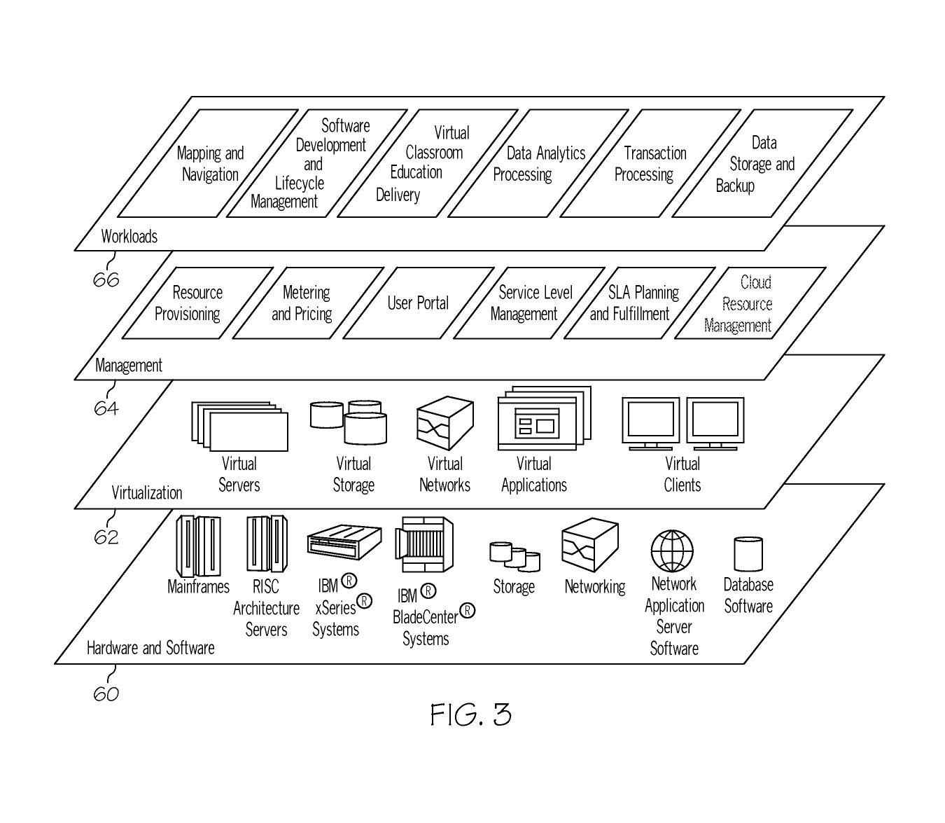

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes. Examples of software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. Consumer portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA. Further shown in management layer is cloud resource management, which represents the functionality that is provided under the embodiments of the present invention.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and organization data storage and backup. As mentioned above, all of the foregoing examples described with respect to FIG. 3 are illustrative only, and the invention is not limited to these examples.

It is understood that all functions of the present invention as described herein typically may be performed by the storage system functionality (of management layer 64, which can be tangibly embodied as modules of program code 42 of program/utility 40 (FIG. 1). However, this need not be the case. Rather, the functionality recited herein could be carried out/implemented and/or enabled by any of the layers 60-66 shown in FIG. 3.

It is reiterated that although this disclosure includes a detailed description on remote storage in a cloud computing environment, implementation of the teachings recited herein are not limited to a cloud computing environment. Rather, the embodiments of the present invention are intended to be implemented with any type of networked computing environment now known or later developed.

Typically, a cloud NAS storage-as-a-service is often used for backups and archiving. Cloud NAS (network attached storage) is remote storage that is accessed over the Internet as if it was local. The storage is sometimes hosted by a third-party service provider who charges the customer a fee based on capacity and bandwidth. In the enterprise, the off-site storage might be proprietary, but the chargeback method would be similar.

The present invention provides a file storage management solution via a cloud NAS file server (or “cloud disk”). A key benefit is that data in the cloud can be accessed at any time from any place. The file storage management solution provides a virtual desktop interface (VDI) to manage the configuration of the file server and individual (or personal) files. A VDI is the server computing model enabling desktop virtualization within a virtual machine (VM), encompassing the hardware and software systems required to support the virtualized environment.

The VDI may be used by a user client device to interact with management services. A management services layer may provide the management services for the user client device. Management services may include using requests that are configurable by the user client device to perform operations relating to the management of the data.

Many enterprise-level implementations of this technology store the resulting “virtualized” desktop on a remote central server instead of on the local storage of a remote client; thus, when users work from their local machine, all of the programs, applications, processes, and data used are kept on the server and run centrally. This allows users to run an operating system and execute applications from a smartphone or thin client which exceed the user hardware's ability to run. The cloud storage also allows companies to make use of such storage for public and personal files, as well as backup, archival, and disaster recovery.

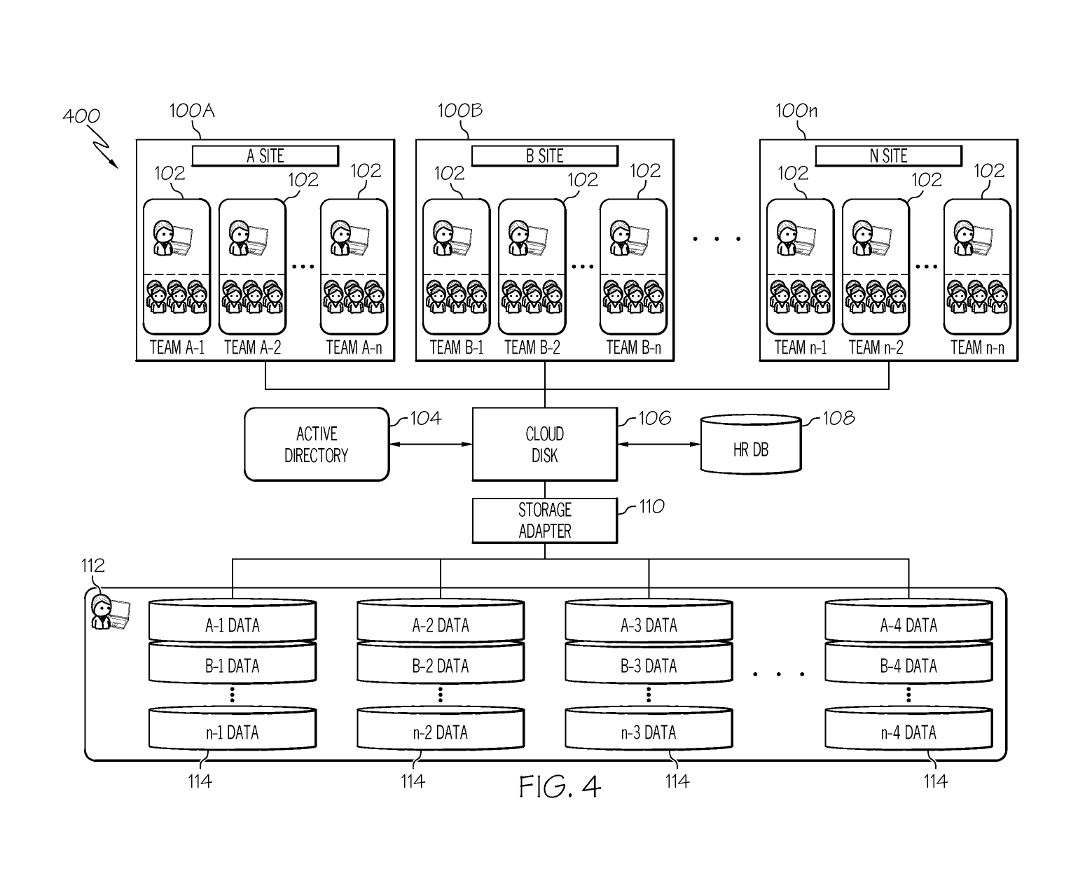

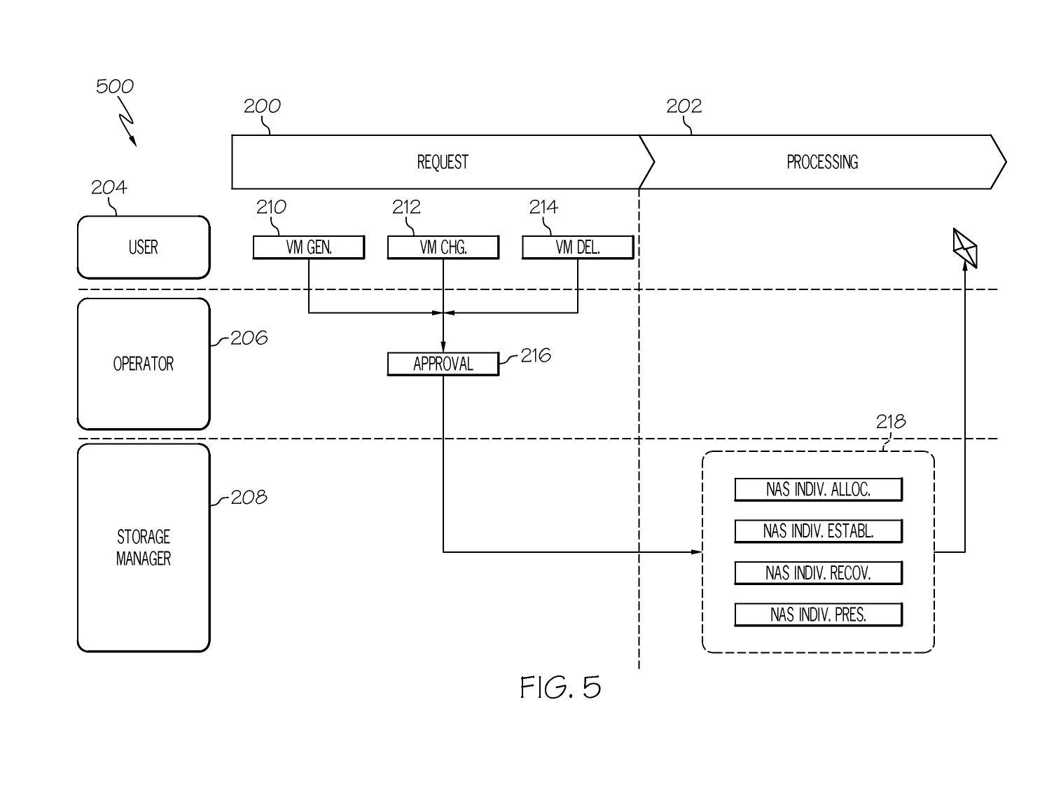

Embodiments of the present invention provide an integrated file server management and individual folder management solution which utilizes a unified data storage architecture in network environment. File server management is described in greater detail with reference to FIG. 4. Individual folder management is described in greater detail with reference to FIG. 5. The present invention provides centralized control over individual data storage services within a unified cloud storage environment.

Referring now to FIG. 4, a file server management solution 400 according to an aspect of the present invention is shown. Any number of “sites” may be included in the file server management solution. Each site may represent an enterprise or business organizations, whether non-profit or for-profit, and may represent an individual or a non-business organization as well. Each site may represent a single geographical location or multiple geographical locations. As depicted, file server management solution 400 includes A Site 100A, B Site 100B, and N Site 100n.

Each site includes any number of teams 102. For example, A Site 100A includes Team A-1, Team A-2, and Team A-n. A direct wireless communication link or an indirect wireless communication link is provided between each site and cloud disk 106. In one example, cloud disk 106 is a cloud NAS file server. Cloud disk 106 provides centralized network file storage, sharing and backup services to individuals, groups and businesses. For example, cloud disk 106 provides shared folder generation and a usage policy for each of the teams 102 of the different sites.

Team members may access the cloud disk 106 using a client (not shown). A client (i.e., user client device) may be any computing clients in a typical client-server configuration. The client may represent computing processing units that have ability to access a network cloud. Examples of clients may include personal computers, personal digital assistant (PDA), mobile devices (e.g., cell phones, mobile computers). The connectivity may be wired or wireless. The clients may transfer or receive data to or from cloud NAS units. The cloud NAS units may be units having cloud NAS. The storage capacity of the cloud NAS unit may be large, ranging from a few Gigabytes (GBs) or TeraBytes (TBs).

Cloud disk 106 connects to Active Directory (AD) 104 and human (or personnel) resource database (HR DB) 108. In one example, the data stored may be related to a particular individual, team, site, equipment, or the like. AD 104 may provide a variety of network services through a management services layer. AD 104 may be a centralized and standardized system that automates network management of user data, security, and distributed resources, and enables interoperation with other directories. AD 104 may be used by system administrators to store information about users, assign security policies, and deploy software. AD 104 may be used in many different types and size of environments from the very small (a dozen users) to hundreds of thousands of users in a global environment.

HR DB 108 may store data related to the team as a whole, as well as the individual team members. In one example, a usage policy for each team may be stored in HR DB 108.

Cloud disk 106 is connected to storage adapter 110. Storage adapter 110 provides a common interface between a user and the data 114. Data storage architecture may be vendor-specific. Storage adapter 110 virtualizes the multi-vendor products into one image. This allows storage operation to be free from vendor dependency. Storage adapter 110 receives a command from a user and issues a storage command based on the storage information and the vendor.

Storage operator 112 may be responsible for certain storage-related tasks, such as operational and technical support. However, the file server management solution 400 separates the storage operator 112 from other tasks. For example, a team (or a project manager of the team) may create a file or folder within the team boundary. The project manager or other team member may also establish or alter a usage policy associated with team data.

The file server may be designed to provide teams with a secure, backed-up space, to store data and files. It is much more secure than storing files and data on a team member's computer's local hard drive. The secure storage environment decreases the potential for teams to lose their critical data due to disk failures, theft, viruses, and accidental deletion, among other things. In one example, the storage disks may be backed up at incremental periods.

FIG. 5 depicts a schematic for an individual folder management processing flow 500 according to an aspect of the present invention. The individual storage management solution 500 provides individual storage folders on the file server to which users have access. The primary purpose is to provide a centralized storage location for team-related files and data. Typically, files saved on the server would include Word documents, Excel spreadsheets, email archives, and any other critical data and team member-created content. In some embodiments, the server may also store programs and applications (i.e., files ending with “.exe”) for use by a respective team.

The individual folder management processing flow 500 includes a user 204, an operator 206, and a storage manager 208. A request 200 by user 204 relating to an individual folder is received. Processing 202 of the request 200 occurs. An example request 200 may include virtual machine (VM) generation 210, VM change 212, and/or VM deletion. A VM is a software implementation of a machine (i.e., a server) that stores data like a physical machine. The virtual machine provides a complete storage platform which supports the storage of a team and/or individual data. Having a virtual machine leads to more efficient use of computing resources, both in terms of energy consumption as well as cost effectiveness.

When user 204 wishes to generate a storage space, a VM generation 210 request is processed. When the request is processed, the individual NAS storage area is automatically generated. The newly created individual NAS (i.e., the storage space) in the cloud environment is established and a VM is connected automatically to the storage space.

When user 204 wishes to make a change to a storage space, a VM change 212 request is processed. Upon creating a storage space, certain fundamental properties are locked in place. After creating a storage space, properties that do not affect fundamental characteristics may be changed, such as the size of the storage space and its name.

When user 204 wishes to delete (or free) a storage space, a VM deletion 214 request is processed. When a user 204 does not need the data storage space any more, the user 204 may free the virtual storage. In one example, deleting the storage space may include removing an entry related to the data storage space from a data storage access list. In one example, operator 206 may approve request 200. If approval is granted, the request 200 is then processed. Under the VM, the individual NAS in the cloud environment may be managed. For example, management functions may include NAS individual allocation, NAS individual establishment, NAS individual recovery, and NAS individual recovery, among others.

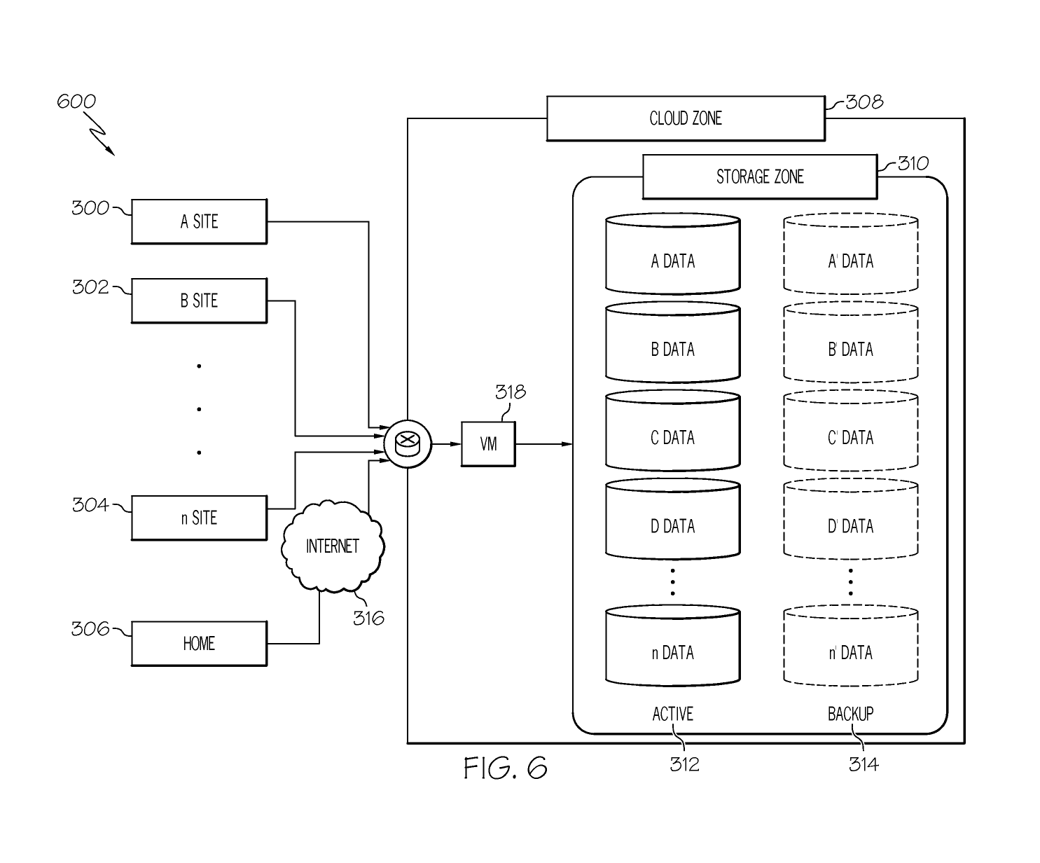

Referring now to FIG. 6, a schematic for a cloud NAS management system 600 according to an aspect of the present invention is shown. The cloud NAS management system 600 includes A site 300, B site 302, n site 304, and home 306 location. The system may be used to manage any number of sites and/or locations. Home 306 is an example location. In other examples, any location may be used, such as an Internet café, restaurant, or other remote location. Cloud zone 308 includes VM 318 and storage zone 310. Storage zone 310 may include active data storage disks 312 and/or backup data storage disks 314. Any number of data storage disks may be used in storage zone 310.

While shown and described herein as a network attached storage management solution in a cloud computing environment, it is understood that the invention further provides various alternative embodiments. For example, in one embodiment, the invention provides a computer-readable/useable medium that includes computer program code to enable a computer infrastructure to provide network attached storage management in a cloud computing environment functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide network attached storage management functionality in a cloud computing environment. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for managing network attached storage in a cloud computing environment. In this case, a computer infrastructure, such as computer system 12 (FIG. 1), can be provided, and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A network-attached storage (NAS) management system in a cloud computing environment, comprising:
a network connection; and
a server, comprising:
a processor, memory, and a computer-readable storage medium;
an operating environment stored on the computer-readable storage medium and executing on the processor;
a storage adapter through which to communicate with a plurality of network storage clients via the network connection, wherein the plurality of network storage clients comprise a unified storage zone for storing data, wherein at least part of the unified storage zone is allocated to a site as site data;
a virtual desktop interface (VDI) that is used by a user client device to interact with management services; and
a management services layer that provides the management services for the user client device, wherein the management services comprise using requests that are configurable by the user client device and wherein the requests are used to perform operations relating to the management of the site data.

2. The NAS management system of claim 1, wherein the management services comprise file server management operations.

3. The NAS management system of claim 1, wherein the management services comprise individual file management operations.

4. The NAS management system of claim 1, wherein at least a part of the site data is allocated to a team within the site as team data.

5. The NAS management system of claim 4, wherein the team data comprises data related to at least one of team personnel or team equipment.

6. The NAS management system of claim 4, wherein the server is configured to perform operations on the team data based on a team usage policy.

7. The NAS management system of claim 1, wherein the network connection is an Internet connection.

8. A method for managing a network-attached storage (NAS) management system in a cloud computing environment, comprising:
providing a server configured to communicate with a plurality of network storage clients using a storage adapter via a network connection, wherein the plurality of network storage clients comprise a unified storage zone for storing data, wherein at least part of the unified storage zone is allocated to a site as site data;
providing a virtual desktop interface (VDI) that is used by a user client device to interact with management services; and
providing a management services layer that provides the management services for the user client device, wherein the management services comprise using requests that are configurable by the user client device and wherein the requests are used to perform operations relating to the management of the site data.

9. The method of claim 8, wherein the management services comprise file server management operations.

10. The method of claim 8, wherein the management services comprise individual file management operations.

11. The method of claim 8, further comprising allocating at least a part of the site data to a team within the site as team data.

12. The method of claim 11, wherein the team data comprises data related to at least one of team personnel or team equipment.

13. The method of claim 11, further comprising performing operations on the team data based on a team usage policy.

14. The method of claim 8, wherein the network connection is an internet connection.

15. A computer program product for managing a network-attached storage (NAS) management system in a cloud computing environment, the computer program product comprising a computer readable storage media, and program instructions stored on the computer readable storage media, to:
communicate with a plurality of network storage clients using a network adapter via a network connection, wherein the plurality of network storage clients comprise a unified storage zone for storing data;
allocate at least part of the unified storage zone is allocated a site as site data;
establish a virtual desktop interface (VDI) that is used by a user client device to interact with management services;
establish a management services layer that provides the management services for the user client device, wherein the management services comprise using a request that is configurable by the user client device; and
perform operations relating to the management of the site data based on the request.

16. The computer program product of claim 15, wherein the management services comprise file server management operations.

17. The computer program product of claim 15, wherein the management services comprise individual file management operations.

18. The computer program product of claim 15, the computer readable storage medium further comprising instructions to allocate at least a part of the site data to a team within the site as team data.

19. The computer program product of claim 18, wherein the team data comprises data related to at least one of team personnel or team equipment.

20. The computer program product of claim 18, the computer readable storage medium further comprising instructions to perform operations on the team data based on a team usage policy.
